(19) United States
(12) Patent Application Publication
(10) Pub. No.: US 2023/0400076 A1
(43) Pub. Date: Dec. 14, 2023

(54) BRAKE DISC

(71) Applicant: Sunstar Engineering Inc., Osaka (JP)

(72) Inventors: Satoshi KUBOTA, Osaka (JP); Akihito OHATA, Osaka (JP)

(21) Appl. No.: 18/252,669

(22) PCT Filed: Nov. 17, 2021
(86) PCT No.: PCT/JP2021/042150

§ 371 Date: May 11, 2023

(30) Foreign Application Priority Data
Nov. 18, 2020 (JP) 2020-191643

(51) Int. Cl. F16D 65/12

(52) U.S. Cl. CPC F16D 65/125; F16D 2200/0021; F16D 2200/0013; F16D 2065/1328

(57) ABSTRACT

Provided is a brake disc having excellent cracking resistance. A brake disc 1 according to an aspect of the present invention comprises a plurality of drain recesses 3, each formed in an area against which a brake pad is abutted, wherein the angle of a shoulder portion 31 formed by a friction surface against which the brake pad is abutted and an inner peripheral surface of an opening of the drain recess 3 is an obtuse angle.

### TECHNICAL FIELD

The present invention relates to a brake disc.

### BACKGROUND ART

For example, as a braking device for a vehicle, a disc brake device is widely used in which a brake disc rotating together with a rotating shaft is sandwiched between brake pads to restrain the rotation of the rotating shaft by frictional force. In such a disc brake device, if foreign matter such as water or dust enters between the brake disc and the brake pads, braking force is reduced. Thus, there is known a technique of providing draining holes for removing such foreign matter on a brake disc (for example, see Patent Document 1).
Patent Document 1: Japanese Unexamined Patent Application, Publication No. 2016-38030

### DISCLOSURE OF THE INVENTION

### Problems to be Solved by the Invention

In general, brake discs for motorcycles are formed using special stainless steel or the like having high strength, but a brake disc may be formed using relatively inexpensive carbon steel. When draining holes are formed in a brake disc, thermal stress tends to concentrate, and thus cracks starting from the draining holes may occur. Therefore, it is an object of the present invention to provide a brake disc excellent in crack resistance.

### Means for Solving the Problems

A brake disc according to an aspect of the present invention includes a plurality of draining recesses formed in a region that a brake pad contacts. An angle of a shoulder portion formed by a friction surface that the brake pad contacts and an inner peripheral surface of an opening portion of each of the draining recesses is obtuse.

In the brake disc, the angle of the shoulder portion may be 135° or more and 175° or less.

In the brake disc, the draining recesses may be conical.

In the brake disc, the positions of the draining recesses on one of the friction surfaces may differ from the positions of the draining recesses on the other of the friction surfaces.

In the brake disc, the draining recesses each may have an opening diameter of 7 mm or more and 15 mm or less.

The brake disc may be formed from carbon steel, cast iron, or stainless steel each having a tensile strength of 800 MPa or less.

The brake disc may be formed from carbon steel or cast iron.

### Effects of the Invention

According to the present invention, a brake disc excellent in crack resistance can be provided.

### BRIEF DESCRIPTION OF THE DRAWINGS

FIG. 1 is an elevation view of a brake disc according to a first embodiment of the present invention;

FIG. 2 is a partial sectional view of the brake disc in FIG. 1;

FIG. 3 is a partial sectional view of a brake disc according to a second embodiment of the present invention; and

FIG. 4 is a partial sectional view of a brake disc according to a third embodiment of the present invention.

### PREFERRED MODE FOR CARRYING OUT THE INVENTION

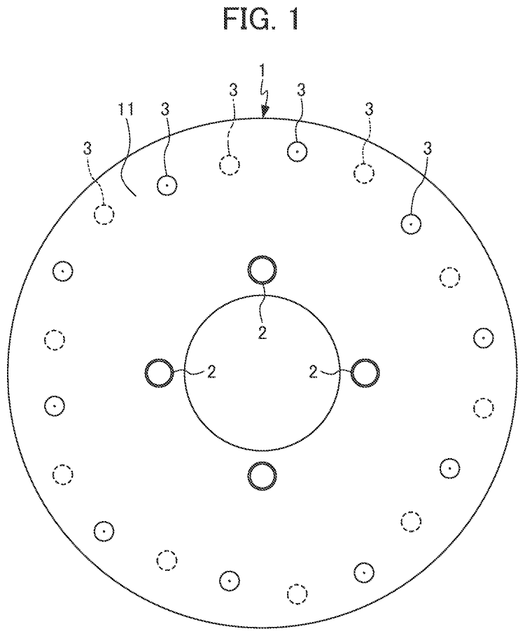

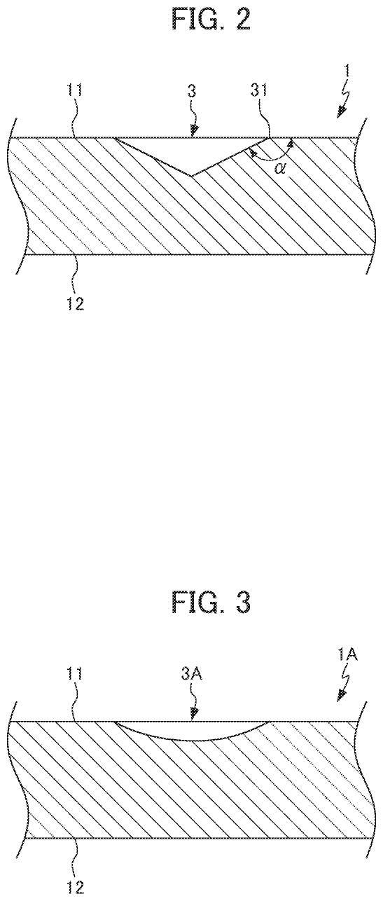

Hereinafter, embodiments of the present invention will be described with reference to the drawings. FIG. 1 is an elevation view (viewed from an axial direction) of a brake disc 1 according to a first embodiment of the present invention. FIG. 2 is a partial sectional view of the brake disc 1 in FIG. 1.

The brake disc 1 is used in a disc brake device. Specifically, the brake disc 1 is formed in a doughnut-shaped flat annular shape in front view, is fixed to a rotating shaft (typically an axle) (not shown) to rotate with the rotating shaft, and is sandwiched between brake pads (not shown) to brake the rotating shaft. That is, both surfaces of the brake disc 1 constitute friction surfaces 11 and 12 that the brake pads contact.

The brake disc 1 includes a plurality of mounting holes 2 for fixing the brake disc 1 to a hub provided on an inner peripheral side of the brake disc 1 in front view, and a plurality of draining recesses 3 formed in a region that a brake pad contacts outward of the mounting holes 2.

The thickness of the brake disc 1 can be, for example, 2 mm or more and 60 mm or less, depending on the output of the rotating shaft to be braked. The inner diameter of the brake disc 1 is selected depending on a hub or the like provided on the rotating shaft, and can be, for example, 40 mm or more and 300 mm or less. The outer diameter of the brake disc 1 is selected so as to secure the contact area of the brake pad necessary to obtain the required braking force in the installation space of the disc brake device, and can be, for example, 100 mm or more and 400 mm or less.

The brake disc 1 can be formed from, for example, carbon steel, cast iron, stainless steel, or the like. However, when the brake disc 1 is formed from a material having a tensile strength of 800 MPa or less in mechanical properties, such as a relatively inexpensive structural carbon steel, typically a mechanical structural carbon steel such as S50C, S53C, S55C, or S58C (JIS-G4051:2016), or cast iron, typically a gray iron casting (JIS-G5501:1995), or a spheroidal graphite iron casting (JIS-G5502:2007), the effect of the present invention of improving crack resistance becomes significant.

The mounting hole 2 is usually used to fix the brake disc 1 to the hub with a bolt. Therefore, the diameter of each of the mounting holes 2 and the number of the mounting holes 2 are selected depending on the required braking torque. In general, the mounting holes 2 are formed at equal distances from the center of the brake disc 1 and at equal intervals in the circumferential direction.

The draining recesses 3 exert a draining effect of draining water adhering to the surface of the brake disc 1 and a cleaning effect of conditioning the rough surface of the brake pad due to entrapment of dust or the like. This can suppress the decrease in the friction force generated between the brake disc 1 and the brake pad and the occurrence of abnormal wear.

The draining recesses 3 are each formed in a circular shape in front view. The positions of the draining recesses 3 on one friction surface 11 preferably differ from the positions of the draining recesses 3 on the other friction surface 12. This allows the position of the stress concentration to be differentiated between the friction surfaces 11 and 12, so that the maximum value of the thermal stress can be suppressed. The draining recesses 3 on one friction surface 11 and the draining recesses 3 on the other friction surface 12 are preferably formed having the same pattern but are angularly displaced in the circumferential direction with respect to each other, to equalize the draining effect on both surfaces.

The brake disc 1 may include a plurality of sets (groups) of draining recesses 3 located at different distances from the center. In the present embodiment, on each of the friction surfaces 11 and 12, a first group consisting of five draining recesses 3 formed at a first distance from the center and at equal intervals in the circumferential direction, and a second group consisting of five draining recesses 3 formed at a second distance from the center and at equal intervals in the circumferential direction are formed. By providing the draining recesses 3 having different distances from the center in this manner, the draining effect can be improved.

The diameter of the draining recess 3 increases toward the friction surface 11 or 12 that the brake pad contacts, at least at the opening portion, and the angle α of a shoulder portion 31 formed by the friction surface 11 or 12 that the brake pad contacts and the inner peripheral surface of the opening portion of the draining recess 3 is obtuse. This reduces the stress concentration on the shoulder portion 31, thus suppressing the maximum value of the thermal stress caused by frictional heat. It should be noted that the inner peripheral surface of the opening portion does not mean a small surface formed by fine chamfering, but means a surface having a width of 1 mm or more and defining a substantial shape.

In the present embodiment, the draining recess 3 is formed in a conical shape, and the inclination angle of the inner peripheral surface is constant as a whole. Thus, the conical shape of the draining recess 3 can effectively reduce the maximum value of the thermal stress. Furthermore, the conical draining recess 3 can be easily formed. Specifically, the conical draining recess 3 can be easily formed in a single step by drilling.

The lower limit of the angle α of the shoulder portion 31 is preferably 135°, and more preferably 155°. The upper limit of the angle α of the shoulder portion 31 is preferably 175°, and more preferably 165°. By setting the angle α of the shoulder portion 31 to be equal to or greater than the lower limit, the maximum value of the thermal stress can be reduced. Furthermore, by setting the angle α of the shoulder portion 31 to be equal to or less than the upper limit, the volume of the draining recess 3 can be ensured and a sufficient draining effect can be obtained. Furthermore, by reducing the angle α of the shoulder portion 31, it becomes easy to form the draining recess 3. For example, since the tip angle of the drill is about 140° at the maximum, the draining recess 3 forming the shoulder portion 31 having an angle α of 160° or less can be easily formed using the drill.

The lower limit of the opening diameter of the draining recess 3 is preferably 7 mm, and more preferably 8 mm. The upper limit of the opening diameter of the draining recess 3 is preferably 15 mm, and more preferably 12 mm. By setting the opening diameter of the draining recess 3 to be equal to or greater than the lower limit, the volume of the draining recess 3 is ensured, and an effective draining effect can be obtained. Furthermore, by setting the opening diameter of the draining recess 3 to be equal to or less than the upper limit, the frictional force between the brake disc 1 and the brake pad can be stabilized.

FIG. 3 is a partial sectional view of a brake disc 1A according to a second embodiment of the present invention. In the following description, explanations that overlap with the embodiment described above may be omitted.

The brake disc 1A includes a plurality of draining recesses 3A formed in regions that the brake pads contact. The only difference between the brake disc 1A in FIG. 3 and the brake disc 1 in FIGS. 1 and 2 is that the shape of each of the draining recesses 3A differs from the shape of each of the draining recesses 3.

The draining recess 3A of the present embodiment has a shape obtained by cutting out a part of a sphere. More specifically, the inner surface of the draining recess 3A is spherical, with the center of the sphere existing significantly outward from the friction surface 11 or 12. Such a draining recess 3A can be formed by, for example, a ball end mill or the like. In the case where the overall thickness of the brake disc 1A is small, for example, the formation of such spherical draining recesses 3A can prevent a reduction in strength due to the thickness becoming too small in some parts.

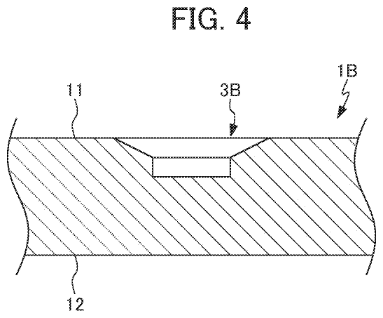

FIG. 4 is a partial sectional view of a brake disc 1B according to a third embodiment of the present invention. The brake disc 1B includes a plurality of draining recesses 3B formed in regions that the brake pads contact. The only difference between the brake disc 1B in FIG. 4 and the brake disc 1 in FIGS. 1 and 2 is that the shape of each of the draining recesses 3B differs from the shape of each of the draining recesses 3.

The draining recess 3B of the present embodiment is formed by increasing the diameter of the opening portion of a cylindrical recess in a conical shape. The draining recess 3B can be formed by combining machining with a drill to form a conical opening portion and machining with a square end mill to form a cylindrical deep portion. Since the volume of the draining recess 3B of the present embodiment can be increased as compared to the draining recess 3 in FIG. 1, the draining effect can be increased while suppressing the maximum value of the thermal stress.

Although the brake disc according to each embodiment of the present invention has been described above, the configuration and effects of the brake disc according to the present invention are not limited to those described above. For example, the brake disc according to the present invention may be one to which a cup-shaped hub is integrally connected, or may have another structure such as notches in the outer peripheral portion.

### Examples

Hereinafter, the present invention will be described in more detail with reference to examples, but the present invention is not limited to these examples.

With respect to brake disc models 1 to 6 each formed from S50C and having a thickness of 7.5 mm, an inner diameter of 155 mm, and an outer diameter of 262 mm, the maximum value of the thermal stress exerted by the frictional heat generated by pressing the brake pad against the friction surface was determined by simulation.

Model 1 included draining recesses each having an opening diameter of 10 mm and a shoulder portion angle of 175°. Model 2 included draining recesses each having an opening diameter of 10 mm and a shoulder portion angle of 160°. Model 3 included draining recesses each having an opening diameter of mm and a shoulder portion angle of 135°. Model 4 included cylindrical non-through holes each having a diameter of 10 mm. Model 5 included through holes each having a diameter of 10 mm. Model 6 included through holes each having a diameter of 12 mm.

The maximum value of the thermal stress for model 1 was 450 MPa. The maximum value of the thermal stress for model 2 was 598 MPa. The maximum value of the thermal stress for model 3 was 798 MPa. The maximum value of the thermal stress for model 4 was 893 MPa. The maximum value of the thermal stress for model 5 was 989 MPa. The maximum value of the thermal stress for model 6 was 1013 MPa.

From the above results, it was confirmed that the brake disc including the draining recesses each having a large shoulder portion angle had a small maximum value of thermal stress and excellent crack resistance.

### EXPLANATION OF REFERENCE NUMERALS

1, 1A, 1B brake disc
11, 12 friction surface
2 mounting hole
3, 3A, 3B draining recess
31 shoulder portion

1. A brake disc, comprising
a plurality of draining recesses formed in a region that a brake pad contacts,
an angle of a shoulder portion formed by a friction surface that the brake pad contacts and an inner peripheral surface of an opening portion of each of the draining recesses being obtuse.

2. The brake disc according to claim 1, wherein the angle of the shoulder portion is 135° or more and 175° or less.

3. The brake disc according to claim 1, wherein the draining recesses are conical.

4. The brake disc according to claim 1, wherein positions of the draining recesses on one of the friction surfaces differ from positions of the draining recesses on the other of the friction surfaces.

5. The brake disc according to claim 1, wherein the draining recesses each have an opening diameter of 7 mm or more and 15 mm or less.

6. The brake disc according to claim 1, wherein the brake disc is formed from carbon steel, cast iron, or stainless steel each having a tensile strength of 800 MPa or less.

7. The brake disc according to claim 1, wherein the brake disc is formed from carbon steel or cast iron.
